(19) United States
(12) Patent Application Publication
(10) Pub. No.: US 2014/0201532 A1
(43) Pub. Date: Jul. 17, 2014

(54) ENHANCED MOBILE SECURITY

(71) Applicant: ENTERPROID HK LTD, Hong Kong (CN)

(72) Inventors: Andrew Jong Kein Toy, New York, NY (US); Alexander Allan Trewby, London (GB); David Wei Zhu, Palo Alto, CA (US); Nadim Tawileh, New York, NY (US)

(73) Assignee: ENTERPROID HK LTD, Hong Kong (CN)

(21) Appl. No.: 13/741,028

(22) Filed: Jan. 14, 2013

Related U.S. Application Data
(63) Continuation of application No. 13/740,789, filed on Jan. 14, 2013.

(51) Int. Cl. H04L 9/08; H04W 12/06

(52) U.S. Cl. CPC H04L 9/08; H04W 12/06
USPC 713/171; 713/168

(57) ABSTRACT

Systems and methods for utilizing a remote server for storing credentials associated with a mobile device. For example, a login credential and/or a token credential can be stored at the remote server rather than at the mobile device. Because these credentials are stored at the remote server, the ecosystem including the mobile device and certain applications or services used by the mobile device can be more secure than conventional architectures.

### CROSS-REFERENCE TO RELATED APPLICATIONS

This application is related to U.S. patent application Ser. No. 13/740,789 filed Jan. 14, 2013 entitled “ENHANCED MOBILE SECURITY”. The entirety of this application is incorporated herein by reference.

### TECHNICAL FIELD

This disclosure generally relates to enhancing mobile security, for example, by storing at a remote server various credentials that are traditionally stored on a mobile device.

### BACKGROUND

Conventionally, phones or other mobile devices store passwords or other credentials in memory included on those device. For example, a password to login, bypass a screen lock, or otherwise gain access to the operating environment of the phone is commonly stored on the phone's file system. When a user attempts to gain access to the operating system, this file can be accessed and the password compared to the user input. While it is common to encrypt the file or other container storing this password, such is still vulnerable to brute force attacks. When the password is all numbers, as is common for mobile devices, brute force attacks become exponentially faster in thwarting the existing security measures.

As another example, many applications or services that require a login generate a token upon successful authentication. This token is used for subsequent authentication in order to avoid continually requesting that the user re-enter the password after the initial authentication. Such tokens are generally stored in system memory of the mobile device and automatically supplied if the application or service performs an authentication challenge. Unfortunately, mobile devices are therefore vulnerable to memory scans capable of copying this token. When such occurs, another device might use the token to gain illicit access to the application or service.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems and methods disclosed herein relate to both client-side and server-side implementations for storing a credential associated with a mobile device at a remote server. A login component can facilitate presentation of a request for a password associated with a login to the mobile device and can receive input associated with the request for the password. A transmission component can transmit the input to a remote server by way of a wireless network associated with the mobile device and can receive a reply regarding a validity of the input.

A security component can exchange an encryption key pair with a remote server, wherein communication between the mobile device and the remote server is signed with an encryption key of the encryption key pair. A token component can receive a cryptographic token in response to a successful authentication to an application or a service. A transmission component can transmit the cryptographic token to a remote server at least partially by way of a wireless network.

The following description and the drawings set forth certain illustrative aspects of the specification. These aspects are indicative, however, of but a few of the various ways in which the principles of the specification may be employed. Other aspects of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level functional block diagram of an example client-side system for storing a login credential for a mobile device at a remote server;

FIG. 2 illustrates a block diagram of various non-limiting examples for invoking the password request;

FIG. 3 illustrates a high-level functional block diagram of an example system that provides for additional features or aspects in connection with a client-side implementation of remote storage of credentials;

FIG. 4 illustrates a high-level functional block diagram of an example server-side system that provides for storing a login credential for a mobile device at a remote server;

FIG. 5 illustrates a high-level functional block diagram of an example system that provides for additional features or aspects in connection with a server-side implementation of remote storage of credentials;

FIG. 6 illustrates a high-level functional block diagram of an example client-side system that provides for storing a token credential for a mobile device at a remote server;

FIG. 7 illustrates a high-level functional block diagram of an example server-side system that provides for storing a token credential for a mobile device at a remote server;

FIG. 8 illustrates an example methodology for storing a login credential for a mobile device at a remote server;

FIG. 9 illustrates an example methodology for storing a token credential for a mobile device at a remote server;

FIG. 10A illustrates an example methodology for setting up a trust relationship between a mobile device and a remote server;

FIG. 10B illustrates an example methodology for providing for additional features or aspects in connection with storing a credential associated with a mobile device at a remote server;

FIG. 11 illustrates an example wireless communication environment with associated components that can enable operation of an enterprise network in accordance with aspects described herein;

FIG. 12 illustrates a block diagram of a computer operable to execute or implement all or portions of the disclosed architecture; and

FIG. 13 illustrates a schematic block diagram of an exemplary computing environment.

### DETAILED DESCRIPTION OVERVIEW

In a traditional mobile operating environment, where users must authenticate to the device, an encrypted form of the user's credentials used for validation is stored in the system. For example, a mobile phone that prompts the user for a password to unlock the phone has that password stored on the phone and encrypted with a one-way hash.

For example, assume H is the hash representing the encrypted password, P is the user password, and F( ) is a hash function (e.g., a one-way hash function), whether a single hash, multiple hashes, or a derivation of single or multiple hashes. In such a case, the mobile device can store H=F(P) on a disk or other local storage. When the user supplies input, I, as the expected credential, the mobile device will perform the following check: Is F(I) equal to H. If yes, then I is equal to P, and the user supplied the correct password.

Mobile devices also typically introduce a random salt, S, into the function as well. For example, the mobile device can calculate H=F(S, P). The mobile device can then store salted hash as: S, H. Such ensures that the hashes of the same password on two different devices or phones will not be the same. In this case, when the user supplies input, I, the mobile device will check if F(S, I) is equal to S, H. As before, if so, then I is equal to P and the user supplied the correct password.

One-way hashes, H, are designed mathematically to be irreversible. Thus, an attacker having access to the hash, where H=F(P), typically does not yield any knowledge of the password, P. However, the environment is still susceptible to brute force attacks. An attacker who obtains the encrypted/hashed credentials from the operating environment can run dictionary or brute force attacks to discover the password. Such a brute force attack can comprise sequentially supplying every possible combination of the password to the hash function until that output equals the credential illicitly acquired.

For example, consider a mobile device that is left unattended for a few moments, perhaps while the user visits the office of a colleague. An attacker can interface to the device and acquire the encrypted/hashed credential, since this file is stored on the device, generally in a location that is known in advance. The credential can then be copied to the attacker's device, an operation that might conceivable only take a few seconds. Alternatively, the attacker might also steal the mobile device. Either way, the attack can quickly withdraw, and thereafter can implement the brute force attack by testing all combinations programmatically until the condition is satisfied and the password is found and with little risk of being discovered.

Although brute force attacks usually require a significant amount of time, such depends on the system being used to break the password as well as the strength of the password, but it is not impossible and becomes much easier if the user's password is comprised of digits only, a situation that is common on phones or other mobile devices.

In order to prevent or substantially reduce the risk of such attacks on mobile devices, the disclosed subject matter provides an architecture for storing the hash, H, on a remote cloud server as opposed to keeping it on the operating environment of the mobile phone. Provided the mobile device can obtain a network connection, such can be entirely seamless to the user. For example, the condition being evaluated can be the same as described above: Is F(S, I) equal to S, H? If yes, then I is equal to P and the user supplied the correct password.

In this case, however, the condition can be evaluated on a remote server in the cloud as opposed to the device. Therefore, if the device is stolen or otherwise compromised, the attacker does not gain access to the credential, which is necessary for attempting brute force attacks on third party devices (e.g., devices of the attacker). As a result, the brute force attack must be accomplished by inputting the test passwords to the stolen mobile device. However, even in that case each attempt will be transmitted to the cloud server, where the comparison is performed, and the cloud server can be configured to gate and throttle checks. For example, the cloud server/service can be implemented such that the password evaluation condition cannot be performed more than X number of times per minute or could potentially lock the account in question and/or notify the user after multiple failed attempts.

Furthermore, the disclosed subject matter can also facilitate storing secure tokens in the cloud server rather than on the mobile device. By way of illustration, some applications and/or services utilize a secure token that is either a derivation of a password, or a token that is unlocked and made available to the user after the user has been authenticated. For example, most services will provide an application with a session ID after successful authentication so the application is not expected to continually send credentials to the service, but rather can simply use the session token. Similarly, some applications will, upon successful authentication, unlock a database token or encryption key that is used for access to protected data.

Typically this token is stored in memory so the application can utilize it for the duration of the session or until there is a session timeout. During the time in which the token is in memory, that token might be obtained by a skilled attacker through a memory scan of the device. Thus, as with login credentials/passwords, instead of storing the token or encryption key in memory of the mobile device (which can be compromised more easily), the token/key can be securely transmitted and stored in the cloud. The device can then reach out to the cloud to obtain the key rather than acquiring the key from local memory. Such can allow the cloud server to enforce better restrictions on duration and other use of the key, while also preventing or mitigating memory scan attacks.

When storing login credentials or token-based credentials at the cloud server, a trust relationship can be established between the client (e.g., mobile device) and the server (e.g., remote cloud server). Such can be accomplished, typically during the setup of the operating environment of the mobile device, by generating and exchanging a key pair such that requests sent to and responses from the server are signed and cannot be spoofed.

### Client-Side Example Storage of Login Credentials at a Cloud Server

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

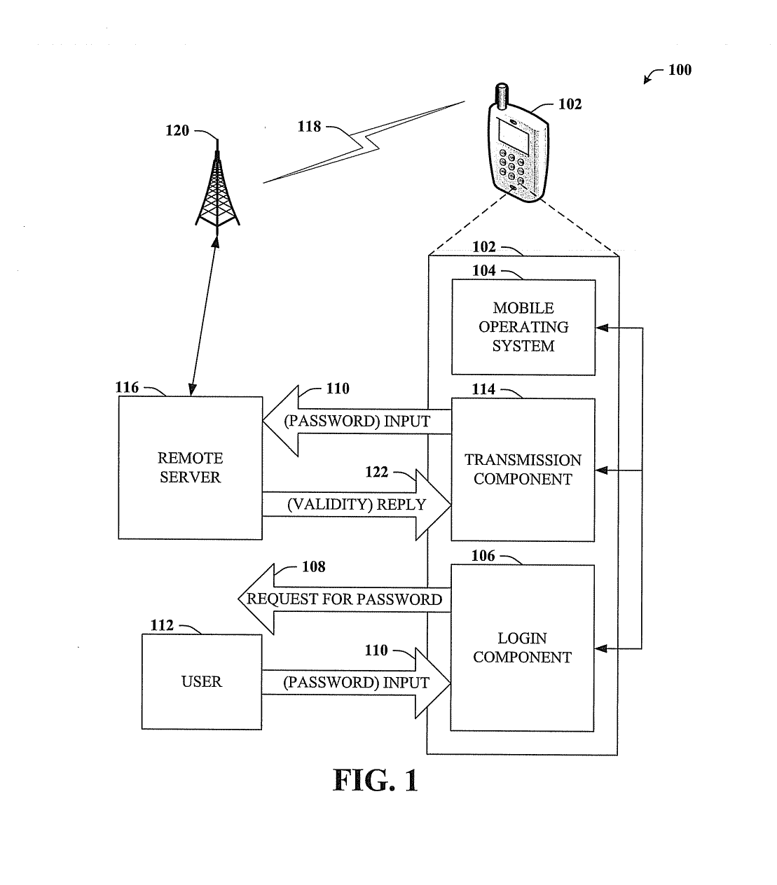

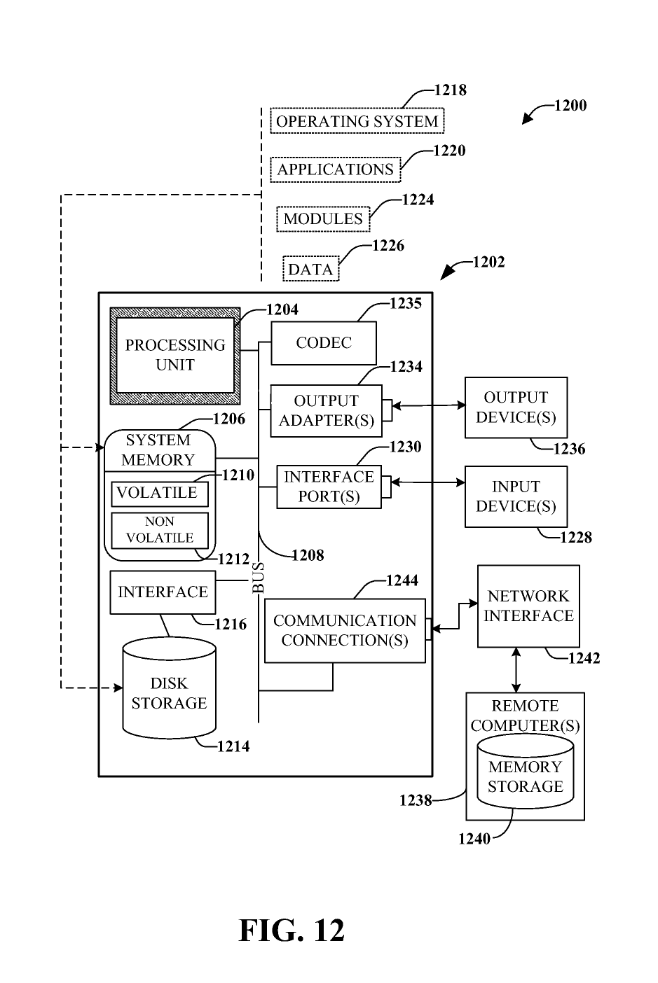

Referring now to drawings, with initial reference to FIG. 1, system 100 is depicted. System 100 provides a client-side example of storing a login credential for a mobile device at a remote server. System 100 can include mobile device 102 that can be for example, a smart phone, a tablet, a personal digital assistant (PDA), or substantially any device that utilizes a mobile operating system. Mobile device 102 can include a memory and a processor, examples of which are provided in connection with FIG. 12. Moreover, the processor can be configured to execute various components described herein.

Mobile device 102 can include mobile operating system 104 that can, for example, include core services that enable applications to access shared data. Thus, any application can potentially have access to common data such as a user's contact information. Such is desirable in that two different contacts applications can access the same information, which can also be the same data accessed by a short message service (SMS) application. Therefore, applications can be created to give users any number of different views on the data, or provide different features or functionality with respect to those data, but the data leveraged for such can be common to all applications. In contrast, desktop-oriented operating systems typically combine application and data in a single monolithic construct. Accordingly, without intimate knowledge of one email application's structure (generally proprietary), a second email application cannot leverage the same data, but rather must use only its own set of data.

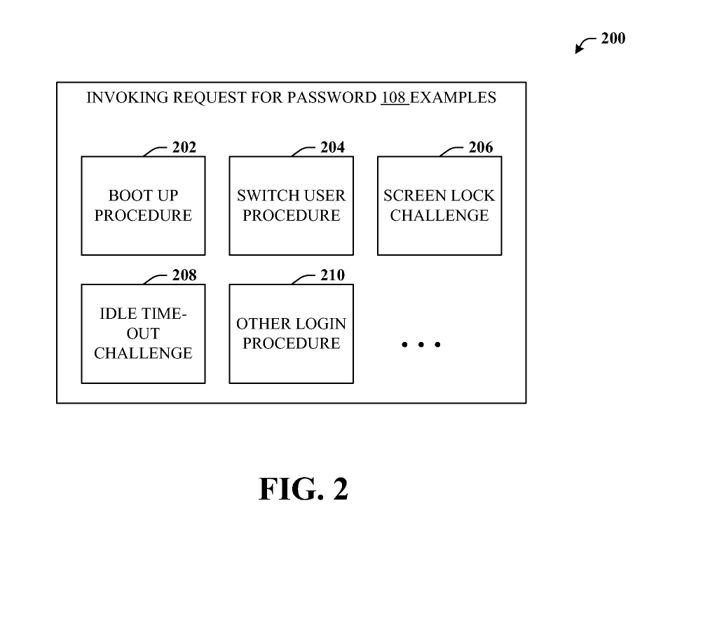

Mobile device 102 can also include login component 106 that can be configured to facilitate presentation of request for password 108 associated with a login to mobile device 102. Login component 106 can be configured to facilitate presentation of request for password 108 due to a variety of circumstances, examples of which are provided with reference to FIG. 2.

While still referring to FIG. 1, but turning briefly to FIG. 2 as well, illustration 200 provides a block diagram of various non-limiting examples for invoking password request 108. For instance, request for password 108 can occur in response to a boot up procedure 202 (e.g., that occurs when mobile device 202 is powered up), a switch user procedure 204 (e.g., that occurs when one user identity or persona logs out and another user identity/persona logs in), screen lock challenge 206 (e.g., that occurs at an access attempt or “tickle” of mobile device 102 after a screen lock has been activated), idle time-out challenge 208 (e.g., that occurs on a tickle of mobile device 102 after the device has been idle for a predetermined period of time), or substantially any other login procedure 210, potentially due to settings or preferences associated with mobile device 102 or a policy maintained by a user or account holder.

Still referring to FIG. 1, login component 106 can further be configured to receive input 110 associated with request for password 108. Typically, input 110 will be received from user 112 in response to request for password 108. Thus, user 112 can enter the password as input 110. Input 110 can be temporarily stored in some volatile memory of mobile device.

Mobile device 102 can further include transmission component 114 that can be configured to transmit input 110 to a remote server 116 by way of a wireless network 118 associated with mobile device 102. For example, input 110 can be transmitted by way of a wireless network (e.g., wireless network 118) maintained by a carrier or service provided associated with mobile device 102 and/or user 112, where input 110 can be received by a selected cell or access point, denoted by reference numeral 120. Thereafter, input 110 can be transmitted, either wirelessly or wired, to remote server 116.

In some embodiments, remote server 116 can deliver an acknowledgement to mobile device 102 that input 110 has been received. Thereafter, in some embodiments, mobile device 102 can purge instances of input 110 from local memory. Regardless, as password validation can occur at remote server 116 (e.g., where the hashed password/credential is stored), transmission component 114 can be configured to receive reply 122 regarding the validity of input 110.

Login component 106 can be further configured to grant access to an operating environment of mobile device 102 in response to reply 122 from remote server 116 indicating input 110 is valid. Login component 106 can be configured to otherwise forbid access to the operating environment in response to reply 122 indicating input 110 is invalid. If reply 122 indicates input 110 is invalid, then the presentation associated with request for password 108 can be invoked again.

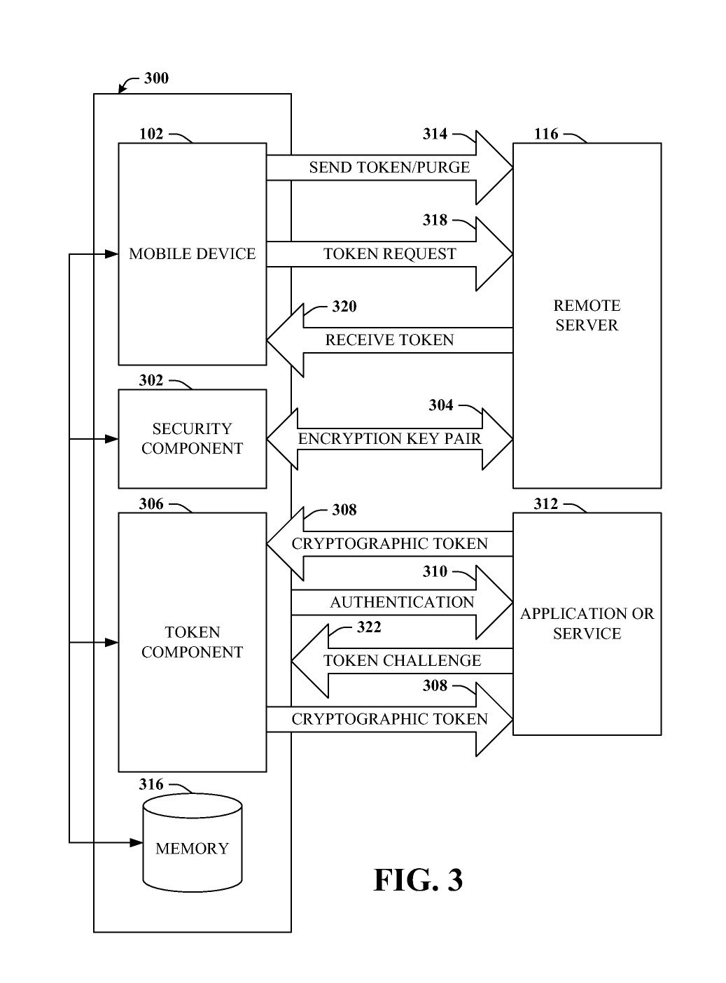

Turning now to FIG. 3, system 300 is depicted. System 300 provides for additional features or aspects in connection with remote storage of credentials. Generally, system 300 can include all or a portion of mobile device 102 such as mobile operating system 104, login component 106, transmission component 114 or other components detailed herein. In addition, system 300 can also include at least one of security component 302, token component 306, and/or memory 316.

Security component 302 can be configured to exchange an encryption key pair 304 with remote server 116 and communication between mobile device 102 and remote server 116 can be signed with an encryption key of encryption key pair 304. For example, both the remote server 116 and mobile device 102 can maintain respective private keys for signing outgoing communications and public keys for decrypting incoming communications. Once signed by a private key, the at least some portion of the communication is encrypted and can only be decrypted by an associated public key. Therefore, if the decryption occurs properly, then the receiving party is assured the communication is from the authenticated sender. In this manner, so-called “spoofing,” where an attacker poses as the authenticated device, can be prevented or substantially mitigated. In some embodiments, security component 302 and remote server 116 can exchange encryption key pair 304 as part of an initial registration with the wireless network 118. In other embodiments, the exchange can occur prior to transmission component 114 sending input 110 to remote server 116.

Token component 306 can be configured to receive a cryptographic token 308 in response to a successful authentication 310 to an application or a service 312. For example, user 112 might desire to access private data on mobile device 102 by way of an application running on mobile device 102. As another example, user 112 might desire to access an account by way of wireless network 118 through a service provided by the maintainer of the account. In either case, the associated application or service 312 will typically require a password login. However, once the correct password has been provided, rather than continually prompting for the password throughout the session, cryptographic token 308 is provided instead, which can be used for subsequent authentication challenges by the application or service 312.

However, unlike conventional systems, where such cryptographic tokens remain stored at local memory of the mobile device, mobile device 102 can forward cryptographic token 308 to remote server 116, in a manner similar to what was done in connection with the login password/credential detailed above. Such is depicted by reference numeral 314, where transmission component 114 of mobile device 102 transmits cryptographic token 308 to remote server 116 by way of wireless network 118 and, upon receipt of an acknowledgement that cryptographic token 308 was received, purges cryptographic token 308 from memory 316 of mobile device 102.

Transmission component 114 can also request cryptographic token 308 from remote server 116, which is denoted as reference numeral 318. Such a token request 318 can occur in response to token challenge 322 from application or service 312. In response to token request 318, remote server 116 can provide cryptographic token 308 to mobile device, labeled as receive token 320, which, in turn can be provided to application or service 312. Subsequently, cryptographic token 308 can be deleted from memory 316.

### Server-Side Example Storage of Login Credentials at a Cloud Server

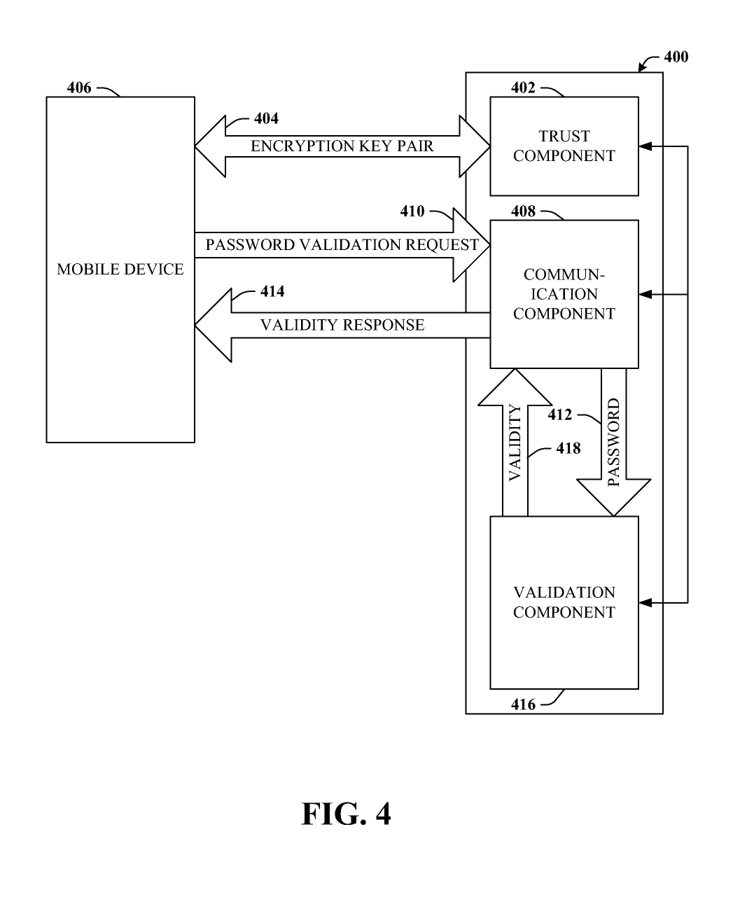

With reference now to FIG. 4, system 400 is depicted. System 400 provides a server-side example of storing a login credential for a mobile device at a remote server. System 400 can exist at a server and can include trust component 402, communication component 408, and validation component 416. Trust component 402 can be configured to exchange an encryption key pair 404 with mobile device 406, wherein communication with the mobile device 406 is signed with an encryption key from encryption key pair 404. Trust component 402 can operate similar to a server-side implementation of security component 302 of FIG. 3.

Communication component 408 can be configured to receive by way of a wireless network a password validation request 410. Password validation request 410 can include password 412 associated with a login to mobile device 406. Communication component 408 can transmit to mobile device 406 by way of the wireless network a response relating to a validity of the password 412, which is denoted as validity response 414.

Validation component 416 can be configured to receive password 412 from communication component 408, and can determine the validity of password 412, typically by applying the one-way hash function, F, to password 412 and comparing the result to the stored credential associated with mobile device 406. If the comparison yields a match, then validity 418 of password 412 can be set as valid. Otherwise, validity 418 of password 412 can be set to invalid. Either way, validity 418 can be provided to communication component 408, which can be included in validity response 414 transmitted to mobile device 406.

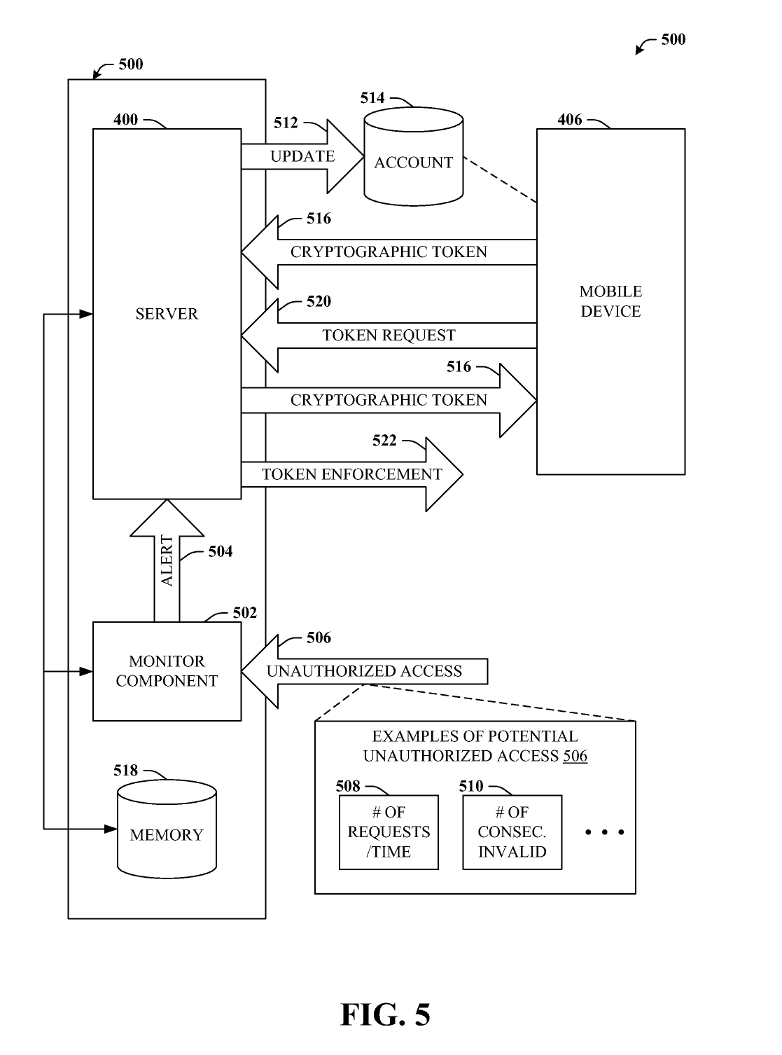

Referring to FIG. 5, system 500 is illustrated. System 500 provides for additional features or aspects in connection with a server-side implementation of remote storage of credentials. Generally, system 500 can include all or a portion of system 400 such as trust component 402, communication component 408, validation component 416, or other components detailed herein. In addition, system 300 can also include at least one of monitor component 502 and/or memory 518.

Monitor component 502 can be configured to generate alert 504 in response to an attempted access to mobile device 406 that is determined to be a potential unauthorized access 506 to mobile device 406. By way of illustration, examples of potential unauthorized access 506 can be based upon a number of requests 410 within a predetermined amount of time exceeding a first threshold (illustrated by reference numeral 508), a number of consecutive password validation requests 410 including an invalid password exceeding a second threshold (illustrated by reference numeral 510), or the like.

In some embodiments, validation component 416 and/or server 400 can, in response to alert 504, update 512 an account 514 associated with mobile device 406. The update 512 to account 514 can provide for various protection schemes. For example, if update 512 occurs, validation component 416 can ignore further password validation requests 410 received and/or facilitate transmission of a warning to mobile device 406 and/or an associated user or accountholder.

In some embodiments, communication component 408 can receive from mobile device 406 a cryptographic token 516 that expires after a predetermined time. The cryptographic token 516 can represent a credential for mobile device 406 used to access an application or a service. Validation component 416 can store cryptographic token 516 to memory 518. Communication component 408 can further retrieve cryptographic token 516 from memory 518 and transmit cryptographic token 516 to mobile device 406 in response to receipt of token request 520. It is appreciated that communications between server 400 and mobile device 406 can be encrypted, which can be accomplished on the server side by trust component 402 and on the client side by security component 302. It is further appreciated that server 400 (e.g., validation component 416 and/or trust component 402) can be configured to enforce cryptographic token 516 time or usage limitations, which is illustrated by reference numeral 522 and is not always adequately accomplished at the client side in conventional systems.

### Client-Side Example Storage of Token Credentials at a Cloud Server

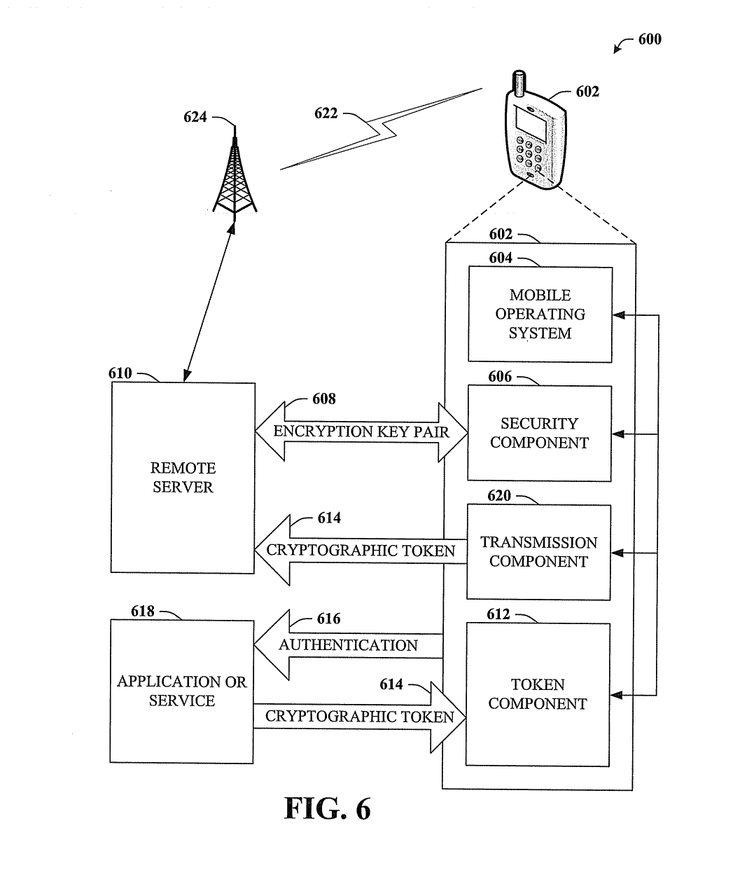

Turning now to FIG. 6, system 600 is depicted. System 600 provides a client-side example of storing a token credential for a mobile device at a remote server. System 100 can include mobile device 602 that can be similar to mobile device 102. For instance, mobile device 602 can be a smart phone, a tablet, a personal digital assistant (PDA), or substantially any device that utilizes a mobile operating system. Mobile device 602 can include a memory and a processor, examples of which are provided in connection with FIG. 12. Moreover, the processor can be configured to execute various components described herein.

Mobile device 602 can include mobile operating system 604 that can be substantially similar to mobile operating system 104. Mobile device 602 can also include security component 606 that can be substantially similar to security component 302, token component 612 that can be substantially similar to token component 306, and transmission component 620 that can be substantially similar to transmission component 114.

For example, security component 606 can be configured to exchange encryption key pair 608 with remote server 610 and communication between mobile device 602 and remote server 610 can be signed with an associated encryption key from encryption key pair 608. Such can establish a trust relationship for subsequent communications.

Token component 612 can be configured to receive cryptographic token 614 in response to a successful authentication 616 to an application or service 618. Transmission component 620 can be configured to transmit cryptographic token 614 to remote server 610 at least partially by way of wireless network 622 and cell, base station, or other access point 624.

In some embodiments, token component 612 can be configured to facilitate deletion of cryptographic token 614 from the memory associated with mobile device 602, particularly after successfully transmitting cryptographic token 614 to the remote server 610 and/or receiving verification that cryptographic token 614 was received by remote server 610. Likewise, token component 612 can subsequently request cryptographic token 614 from remote server 610 in response to a challenge from application or service 618. Cryptographic token 614 can then be transmitted by the remote server 610 and received by token component 612. Upon receipt, cryptographic token 614 can be employed in connection with application or service 618 and thereafter purged from local memory once more.

It is understood that mobile device 602 can also include other components detailed herein such as, for example, a login component that is substantially similar to login component 106 might be included in mobile device 602 as well.

### Server-Side Example Storage of Token Credentials at a Cloud Server

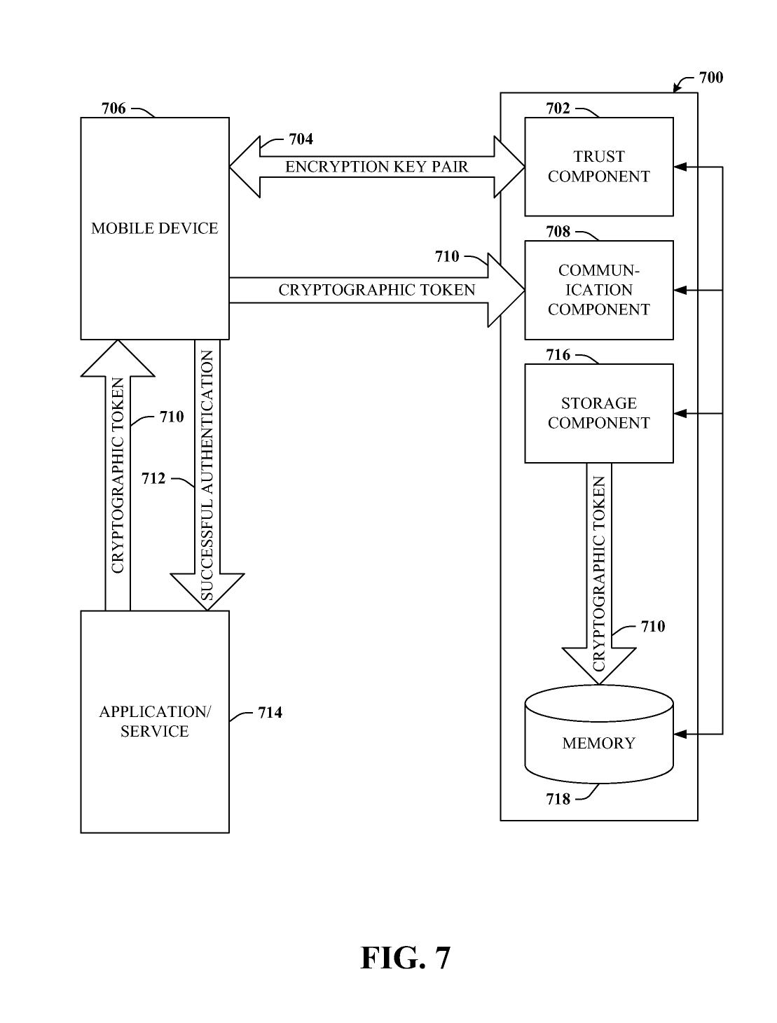

Referring now to FIG. 7, system 700 is depicted. System 700 provides a server-side example of storing a token credential for a mobile device at a remote server. System 700 can include trust component 702 that can be substantially similar to trust component 402. Trust component 702 can be configured to exchange encryption key pair 704 with mobile device 706, wherein communication with mobile device 706 can be signed with an encryption key from encryption key pair 704.

System 700 can also include communication component 708 that can be substantially similar to communication component 408. Communication component 708 can be configured to receive by way of a wireless network cryptographic token 710 that expires after a predetermined time and represents a credential for the mobile device to access application or service 714. For example, mobile device 706 can interface with application or service 714. After successful authentication 712 (e.g., inputting the correct password or the like), mobile device 706 can receive cryptographic token 710, and then transmit cryptographic token 710 to server 700, potentially deleting all references to cryptographic token 710 thereafter. In some embodiments, communication component 708 can transmit an acknowledgement to mobile device 706 indicating cryptographic token 710 was successfully received.

System 700 can further include storage component 716 that can be configured to store cryptographic token 710 to memory 718 on behalf of mobile device 706. In some embodiments, communication component 708 can transmit cryptographic token 710 back to mobile device 706 in response to receipt of a token request from mobile device 706.

It is understood that system 700 can also include other components detailed herein such as, for example, a validation component or a monitor component, that are substantially similar to validation component 416 and monitor component 502, respectively.

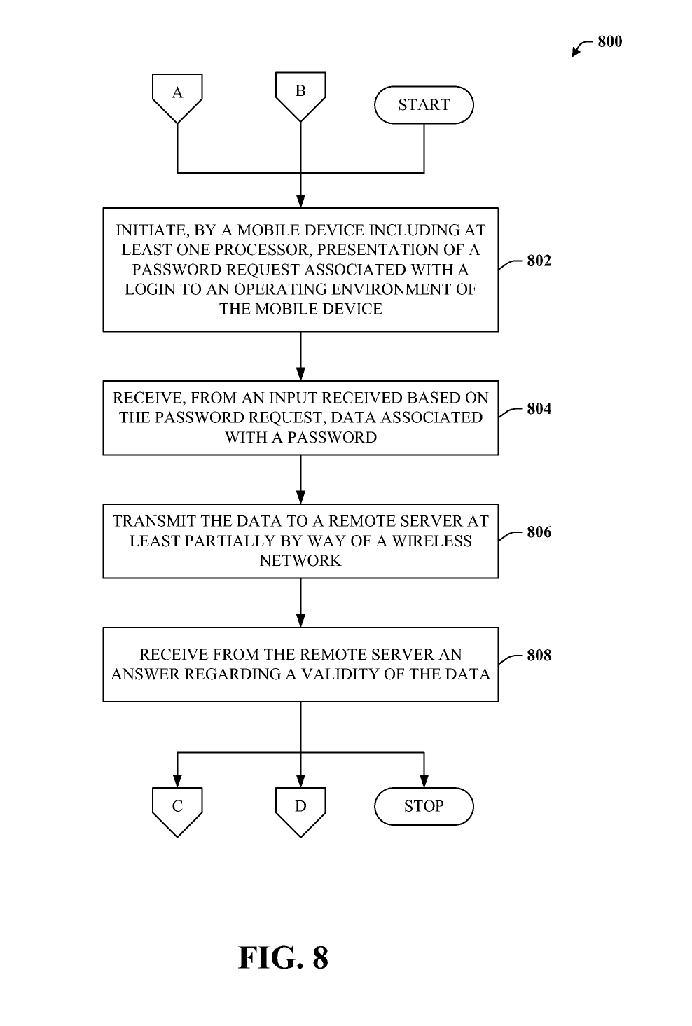

FIGS. 8-10B illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers

Referring now to FIG. 8, exemplary method 800 is illustrated. Method 800 can provide for storing a login credential for a mobile device at a remote server. Generally, at reference numeral 802, a mobile device including at least one processor can initiate presentation of a password request associated with a login to an operating environment of the mobile device.

At reference numeral 804, data associated with a password can be received from an input that is received based upon the password request initiated at reference numeral 802. Hence, the input can be, for example, a password entered by a user in response to the presentation of the password request. At reference numeral 806, the data received at reference numeral 804 can be transmitted to a remote server at least partially by way of a wireless network.

Thereafter, at reference numeral 808, an answer regarding a validity of the data can be received from the remote server. For example, the remote server can perform the validation on the password in contrast to such being performed at the mobile device as is done conventionally. Such can be beneficial because performing the validation at the remote server means it is not necessary to store the associated credential at the mobile device. Therefore, the credential is much less susceptible to attacks, e.g., brute force attacks.

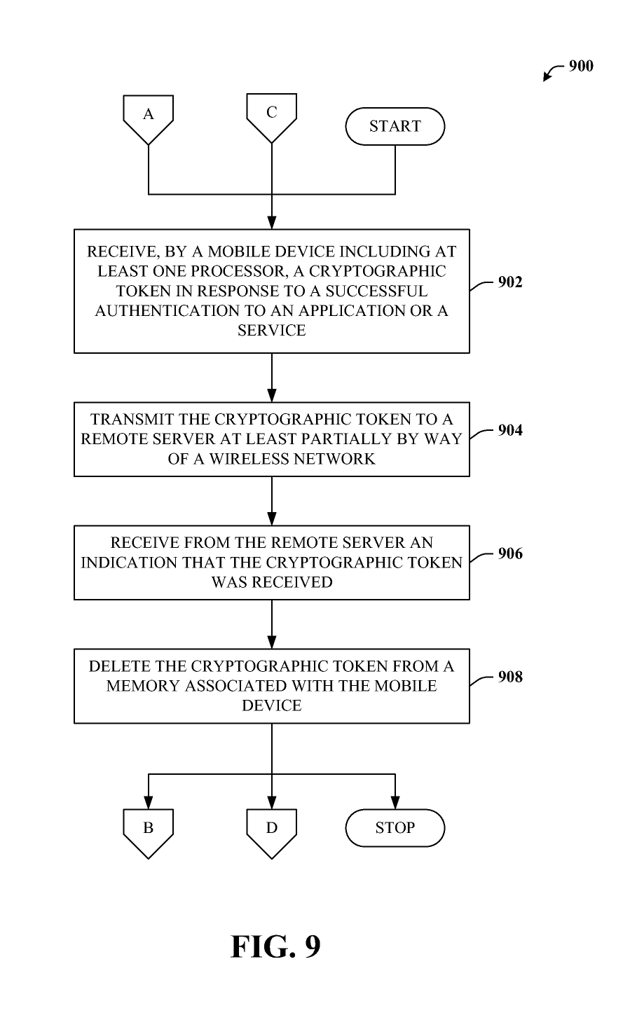

Turning now to FIG. 9, exemplary method 900 is illustrated. Method 900 can provide for storing a token credential for a mobile device at a remote server. Generally, at reference numeral 902, a mobile device including at least one processor can receive a cryptographic token in response to a successful authentication to an application or a service. For example, a user of the mobile device can enter the correct password to access the application or service and be assigned the cryptographic token for use for the remainder of the session with the application or service.

At reference numeral 904, the cryptographic token can be transmitted to a remote server at least partially by way of a wireless network. At reference numeral 906, an indication that the cryptographic token was received can be received from the remote server. At reference numeral 908, the cryptographic token can be deleted from a memory associated with the mobile device

Thereafter, at reference numeral 908, an answer regarding a validity of the data can be received from the remote server. For example, the remote server can perform the validation on the password in contrast to such being performed at the mobile device as is done conventionally. Such can be beneficial because performing the validation at the remote server means it is not necessary to store the associated credential at the mobile device. Therefore, the credential is much less susceptible to attack, making the entire system more secure.

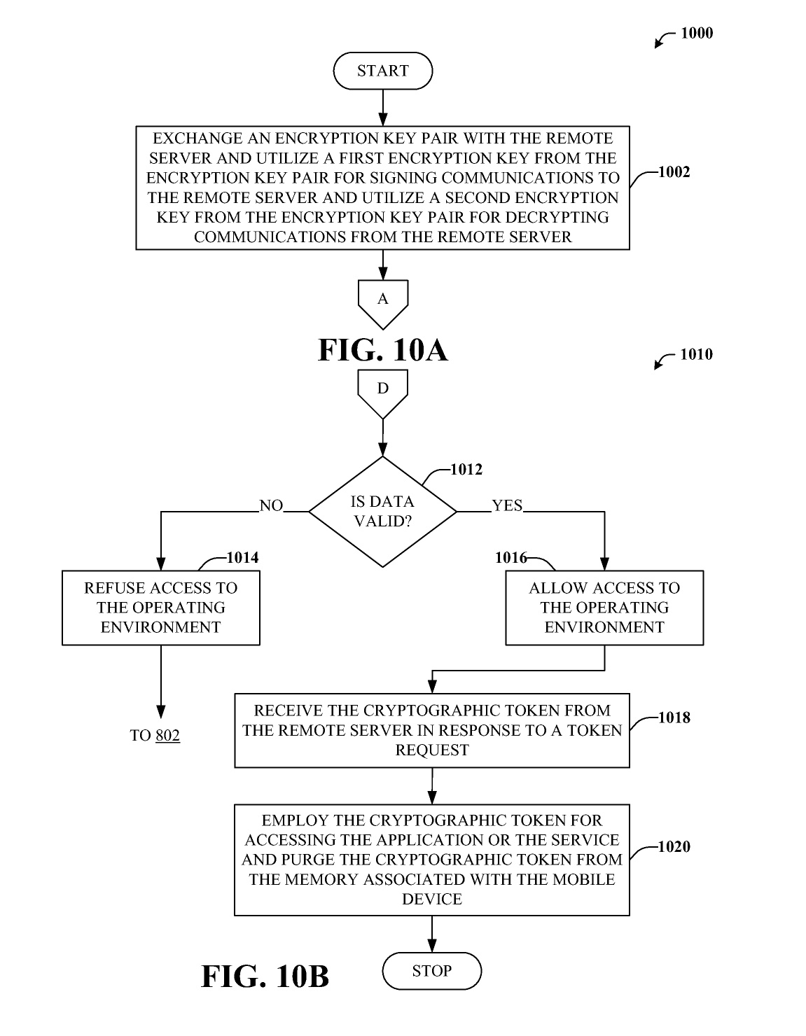

Referring now to FIG. 10A, exemplary method 1000 is depicted. Method 1000 can provide for setting up a trust relationship between a mobile device and a remote server. At reference numeral 1002, an encryption key pair can be exchanged with the remote server. A first encryption key from the encryption key pair can be utilized for signing communications to the remote server and a second encryption key from the encryption key pair can be utilized for decrypting communications from the server. It is understood that method 1000 can then proceed to insert A and can therefore precede the operation of method 800 or method 900.

With reference now to FIG. 10B, exemplary method 1010 is depicted. Method 1010 can provide for additional features or aspects in connection with storing a credential associated with a mobile device at a remote server. At reference numeral 1012, a decision can occur. In particular, it can be determined whether or not the data received in connection with reference numeral 804 is valid. Such a determination can be determined at the remote server and the mobile device can be apprised of the answer at reference numeral 808.

If the data is not valid, then method 1010 proceeds to reference numeral 1014, where access to the operating environment of the mobile device is refused. Thereafter the method can end or proceed to reference numeral 802 in which the presentation of a password request is initiated once more.

If the data is valid, the method 1010 proceeds to reference numeral 1016, where access to the operating environment of the mobile device is allowed. At reference numeral 1018, the cryptographic token can be received from the remote server in response to a token request. Typically, the token request will result from a similar request from the application or service. At reference numeral 1020, the cryptographic token can be employed for accessing the application or the service. Thereafter, the cryptographic token can be purged from all memories associated with the mobile device.

### Example Operating Environments

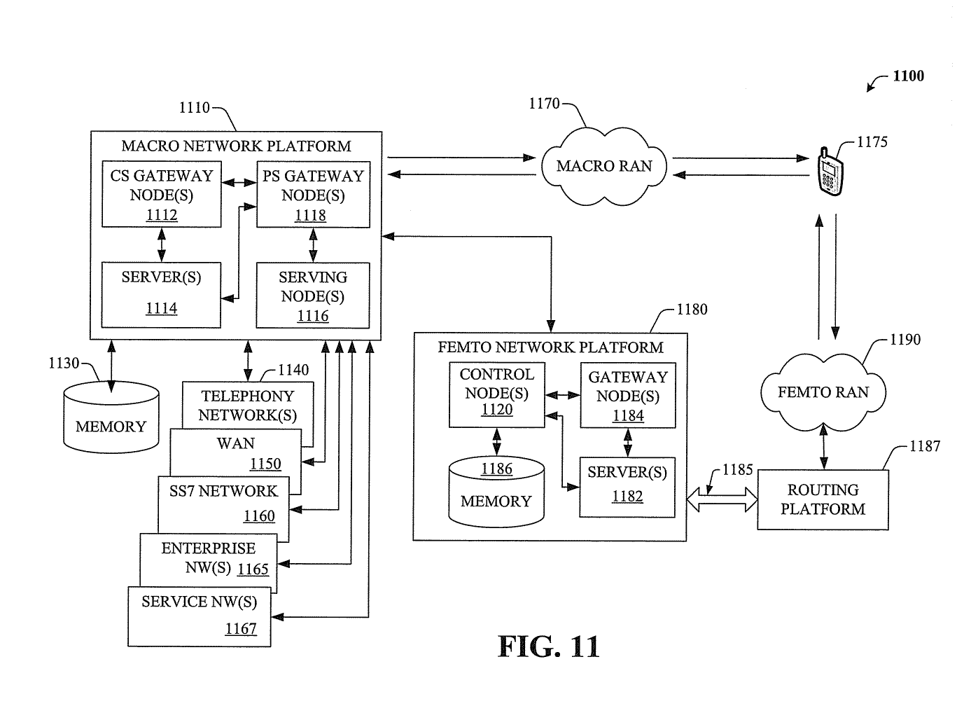

To provide further context for various aspects of the subject specification, FIG. 11 illustrates an example wireless communication environment 1100, with associated components that can enable operation of a femtocell enterprise network in accordance with aspects described herein. Wireless communication environment 1100 includes two wireless network platforms: (i) A macro network platform 1110 that serves, or facilitates communication) with user equipment 1175 via a macro radio access network (RAN) 1170. It should be appreciated that in cellular wireless technologies (e.g., 4 G, 3GPP UMTS, HSPA, 3GPP LTE, 3GPP UMB), macro network platform 1110 is embodied in a Core Network. (ii) A femto network platform 1180, which can provide communication with UE 1175 through a femto RAN 1190, linked to the femto network platform 1180 through a routing platform 112 via backhaul pipe(s) 1185. It should be appreciated that femto network platform 1180 typically offloads UE 1175 from macro network, once UE 1175 attaches (e.g., through macro-to-femto handover, or via a scan of channel resources in idle mode) to femto RAN.

It is noted that RAN includes base station(s), or access point(s), and its associated electronic circuitry and deployment site(s), in addition to a wireless radio link operated in accordance with the base station(s). Accordingly, macro RAN 1170 can comprise various coverage cells like cell 1105, while femto RAN 1190 can comprise multiple femto access points. As mentioned above, it is to be appreciated that deployment density in femto RAN 1190 is substantially higher than in macro RAN 1170.

Generally, both macro and femto network platforms 1110 and 1180 include components, e.g., nodes, gateways, interfaces, servers, or platforms, that facilitate both packet-switched (PS) (e.g., internet protocol (IP), frame relay, asynchronous transfer mode (ATM)) and circuit-switched (CS) traffic (e.g., voice and data) and control generation for networked wireless communication. In an aspect of the subject innovation, macro network platform 1110 includes CS gateway node(s) 1112 which can interface CS traffic received from legacy networks like telephony network(s) 1140 (e.g., public switched telephone network (PSTN), or public land mobile network (PLMN)) or a SS7 network 1160. Circuit switched gateway 1112 can authorize and authenticate traffic (e.g., voice) arising from such networks. Additionally, CS gateway 1112 can access mobility, or roaming, data generated through SS7 network 1160; for instance, mobility data stored in a VLR, which can reside in memory 1130. Moreover, CS gateway node(s) 1112 interfaces CS-based traffic and signaling and gateway node(s) 1118. As an example, in a 3GPP UMTS network, gateway node(s) 1118 can be embodied in gateway GPRS support node(s) (GGSN).

In addition to receiving and processing CS-switched traffic and signaling, gateway node(s) 1118 can authorize and authenticate PS-based data sessions with served (e.g., through macro RAN) wireless devices. Data sessions can include traffic exchange with networks external to the macro network platform 1110, like wide area network(s) (WANs) 1150; it should be appreciated that local area network(s) (LANs) can also be interfaced with macro network platform 1110 through gateway node(s) 1118. Gateway node(s) 1118 generates packet data contexts when a data session is established. To that end, in an aspect, gateway node(s) 1118 can include a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can include multiple flows that can be generated through server(s) 1114. It is to be noted that in 3GPP UMTS network(s), gateway node(s) 1118 (e.g., GGSN) and tunnel interface (e.g., TTG) comprise a packet data gateway (PDG).

Macro network platform 1110 also includes serving node(s) 1116 that convey the various packetized flows of information or data streams, received through gateway node(s) 1118. As an example, in a 3GPP UMTS network, serving node(s) can be embodied in serving GPRS support node(s) (SGSN).

As indicated above, server(s) 1114 in macro network platform 1110 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can include add-on features to standard services provided by macro network platform 1110. Data streams can be conveyed to gateway node(s) 1118 for authorization/authentication and initiation of a data session, and to serving node(s) 1116 for communication thereafter. Server(s) 1114 can also effect security (e.g., implement one or more firewalls) of macro network platform 1110 to ensure network's operation and data integrity in addition to authorization and authentication procedures that CS gateway node(s) 1112 and gateway node(s) 1118 can enact. Moreover, server(s) 1114 can provision services from external network(s), e.g., WAN 1150, or Global Positioning System (GPS) network(s) (not shown). It is to be noted that server(s) 1114 can include one or more processor configured to confer at least in part the functionality of macro network platform 1110. To that end, the one or more processor can execute code instructions stored in memory 1130, for example.

In example wireless environment 1100, memory 1130 stores information related to operation of macro network platform 1110. Information can include business data associated with subscribers; market plans and strategies, e.g., promotional campaigns, business partnerships; operational data for mobile devices served through macro network platform; service and privacy policies; end-user service logs for law enforcement; and so forth. Memory 1130 can also store information from at least one of telephony network(s) 1140, WAN(s) 1150, or SS7 network 1160, enterprise NW(s) 1165, or service NW(s) 1167.

Femto gateway node(s) 1184 have substantially the same functionality as PS gateway node(s) 1118. Additionally, femto gateway node(s) 1184 can also include substantially all functionality of serving node(s) 1116. In an aspect, femto gateway node(s) 1184 facilitates handover resolution, e.g., assessment and execution. Further, control node(s) 1120 can receive handover requests and relay them to a handover component (not shown) via gateway node(s) 1184. According to an aspect, control node(s) 1120 can support RNC capabilities.

Server(s) 1182 have substantially the same functionality as described in connection with server(s) 1114. In an aspect, server(s) 1182 can execute multiple application(s) that provide service (e.g., voice and data) to wireless devices served through femto RAN 1190. Server(s) 1182 can also provide security features to femto network platform. In addition, server(s) 1182 can manage (e.g., schedule, queue, format . . . ) substantially all packetized flows (e.g., IP-based, frame relay-based, ATM-based) it generates in addition to data received from macro network platform 1110. It is to be noted that server(s) 1182 can include one or more processor configured to confer at least in part the functionality of macro network platform 1110. To that end, the one or more processor can execute code instructions stored in memory 1186, for example.

Memory 1186 can include information relevant to operation of the various components of femto network platform 1180. For example operational information that can be stored in memory 1186 can comprise, but is not limited to, subscriber information; contracted services; maintenance and service records; femto cell configuration (e.g., devices served through femto RAN 1190; access control lists, or white lists); service policies and specifications; privacy policies; add-on features; and so forth.

It is noted that femto network platform 1180 and macro network platform 1110 can be functionally connected through one or more reference link(s) or reference interface(s). In addition, femto network platform 1180 can be functionally coupled directly (not illustrated) to one or more of external network(s) 1140, 1150, 1160, 1165 or 1167. Reference link(s) or interface(s) can functionally link at least one of gateway node(s) 1184 or server(s) 1186 to the one or more external networks 1140, 1150, 1160, 1165 or 1167. The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. In addition, according to present innovations, codec 1205 may include at least one of an encoder or decoder, wherein the at least one of an encoder or decoder may consist of hardware, a combination of hardware and software, or software. Although, codec 1205 is depicted as a separate component, codec 1205 may be contained within non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1202 may also include removable/non-removable, volatile/non-volatile computer storage medium. FIG. 12 illustrates, for example, disk storage 1214. Disk storage 1214 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port may be used to provide input to computer 1202 and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

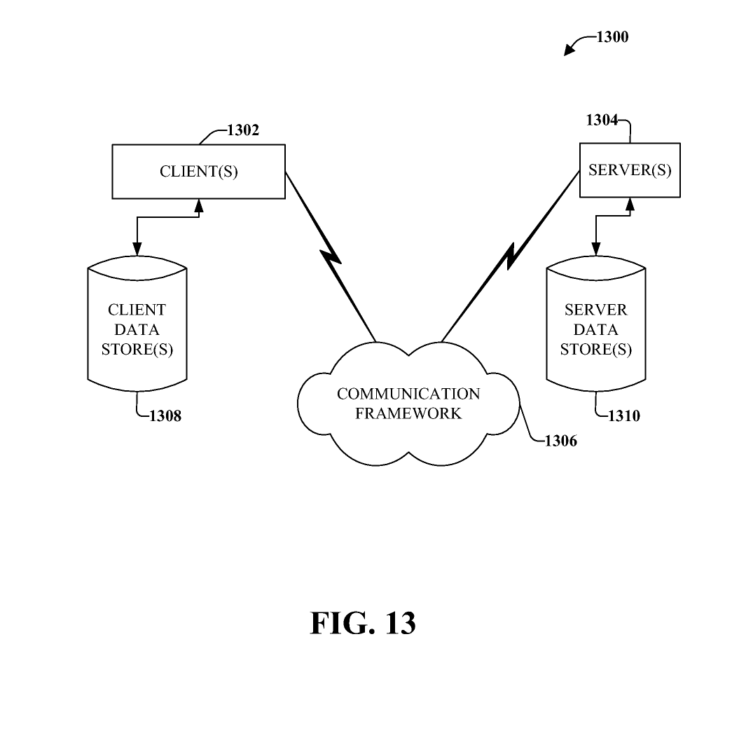

Referring now to FIG. 13, there is illustrated a schematic block diagram of a computing environment 1300 in accordance with this specification. The system 1300 includes one or more client(s) 1302 (e.g., laptops, smart phones, PDAs, media players, computers, portable electronic devices, tablets, and the like). The client(s) 1302 can be hardware and/or software (e.g., threads, processes, computing devices). The system 1300 also includes one or more server(s) 1304. The server(s) 1304 can also be hardware or hardware in combination with software (e.g., threads, processes, computing devices). The servers 1304 can house threads to perform transformations by employing aspects of this disclosure, for example. One possible communication between a client 1302 and a server 1304 can be in the form of a data packet transmitted between two or more computer processes wherein the data packet may include video data. The data packet can include a cookie and/or associated contextual information, for example. The system 1300 includes a communication framework 1306 (e.g., a global communication network such as the Internet, or mobile network(s)) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

In one embodiment, a client 1302 can transfer an encoded file, in accordance with the disclosed subject matter, to server 1304. Server 1304 can store the file, decode the file, or transmit the file to another client 1302. It is to be appreciated, that a client 1302 can also transfer uncompressed file to a server 1304 and server 1304 can compress the file in accordance with the disclosed subject matter. Likewise, server 1304 can encode video information and transmit the information via communication framework 1306 to one or more clients 1302.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

What is claimed is:

1. A mobile device including a mobile operating system, comprising:
a processor that executes computer executable components stored in a memory, the computer executable components comprising:
a security component that exchanges an encryption key pair with a remote server, wherein communication between the mobile device and the remote server is signed with an encryption key of the encryption key pair;
a token component that receives a cryptographic token in response to a successful authentication to an application or a service; and
a transmission component that transmits the cryptographic token to a remote server at least partially by way of a wireless network.

2. The mobile device of claim 1, wherein the token component facilitates deletion of the cryptographic token from the memory after confirmation of a successful transmission of the cryptographic token to the remote server.

3. The mobile device of claim 1, wherein the token component facilitates a request to the remote server for the cryptographic token in response to a challenge from the application or the service.

4. The mobile device of claim 3, wherein the token component receives the cryptographic token, employs the cryptographic token in connection with the application or the service, and purges the cryptographic token from the memory.

5. The mobile device of claim 1, wherein the computer executable components further comprise a login component that facilitates presentation of a request for a password associated with a login to the mobile device and receives input associated with the request for the password.

6. The mobile device of claim 5, wherein the transmission component further transmits the input to a remote server by way of the wireless network and receives a reply regarding a validity of the input.

7. The mobile device of claim 5, wherein the login component facilitates presentation of the request for the password in response to at least one of a screen lock challenge activated on the mobile device, to an idle time-out challenge activated on the mobile device, or a boot-up procedure on the mobile device.

8. The mobile device of claim 6, wherein the login component further grants access to an operating environment of the mobile device in response to the reply from the remote server indicating the input is valid, or forbids access to the operating environment in response to the reply indicating the input is invalid.

9. A server, comprising:
a processor that executes computer executable components stored in a memory, the computer executable components comprising:
a trust component that exchanges an encryption key pair with a mobile device, wherein communication with the mobile device is signed with an encryption key from the encryption key pair;
a communication component that receives by way of a wireless network a cryptographic token that expires after a predetermined time and represents a credential for the mobile device to access an application or a service; and
a storage component that stores the cryptographic token to the memory on behalf of the mobile device.

10. The server of claim 9, wherein the communication component further transmits an acknowledgement indicating the cryptographic token was successfully received.

11. The server of claim 9, wherein the communication component further transmits the cryptographic token to the mobile device in response to receipt of a token request from the mobile device.

12. The server of claim 9, wherein the computer executable components further comprise a validation component that further enforces cryptographic token time or usage limitations.

13. The server of claim 12, wherein the communication component further receives by way of the wireless network a password validation request that includes a password associated with a login to the mobile device, and transmits to the mobile device by way of the wireless network a response relating to a validity of the password.

14. The server of claim 13, wherein the computer executable components further comprise a monitor component that generates an alert in response to an access determined to be a potential unauthorized access to the mobile device.

15. The server of claim 14, wherein the potential unauthorized access relates to a number of password validation requests occurring within a predetermined amount of time exceeding a first threshold.

16. The server of claim 14, wherein the potential unauthorized access relates to a number of consecutive password validation requests including an invalid password exceeding a second threshold.

17. The server of claim 14, wherein the validation component, in response to the alert, updates an account associated with the mobile device and ignores further password validation requests.

18. A method, comprising:
receiving, by a mobile device including at least one processor, a cryptographic token in response to a successful authentication to an application or a service;
transmitting the cryptographic token to a remote server at least partially by way of a wireless network;
receiving from the remote server an indication that the cryptographic token was received; and
deleting the cryptographic token from a memory associated with the mobile device.

19. The method of claim 18, further comprising receiving the cryptographic token from the remote server and employing the cryptographic token for accessing the application or the service.

20. The method of claim 19, further comprising purging the cryptographic token from the memory associated with the mobile device after utilizing the cryptographic token for accessing the application or the service.

21. The method of claim 18, further comprising facilitating presentation of a password request associated with a login to an operating environment of the mobile device and receiving data in response to the password request.

22. The method of claim 18, further comprising transmitting the data to a remote server at least partially by way of the wireless network and receiving, from the remote server, an answer regarding a validity of the data.

23. The method of claim 22, further comprising allowing access to the operating environment in response to the answer indicating the data is valid.

24. The method of claim 22, further comprising refusing access to the operating environment in response to the answer indicating the data is invalid.

25. The method of claim 24, further comprising repeating the presentation of the password request in response to the answer indicating the data is invalid.

26. The method of claim 18, further comprising exchanging an encryption key pair with the remote server and utilizing a first encryption key from the encryption key pair for signing communications to the remote server and utilizing a second encryption key from the encryption key pair for decrypting communications from the remote server.
